(19) United States
(12) Patent Application Publication
(10) Pub. No.: US 2009/0201308 A1
(43) Pub. Date: Aug. 13, 2009

(54) Method for setting operating parameters of a data processing system

(76) Inventors: Oliver Graf, Erlangen (DE); Hans-Martin Von Stockhausen, Erlangen (DE)

Correspondence Address: HARNESS, DICKEY & PIERCE, P.L.C., P.O.BOX 8910, RESTON, VA, 20195, US

(21) Appl. No.: 12/320,865

(22) Filed: Feb. 6, 2009

(30) Foreign Application Priority Data
Feb. 8, 2008 (DE) 10 2008 008 048.9

(51) Int. Cl. G09G 5/00

(52) U.S. Cl. 345/581

(57) ABSTRACT

A method is disclosed for setting operating parameters of a data processing system having at least one display device. In at least one embodiment, the method includes providing a graphic parameter file which specifies at least one geometric parameter of a graphic element displayable on the display device; providing a device parameter file which specifies parameters of the display device; and automatically linking the graphic parameter file with the device parameter file such that the graphic element is displayed with the specified at least one geometric property on the at least one display device, independently of the at least one specified parameter of the display device.

### PRIORITY STATEMENT

The present application hereby claims priority under 35 U.S.C. §119 on German patent application number DE 10 2008 008 048.9 filed Feb. 8, 2008, the entire contents of which is hereby incorporated herein by reference.

### FIELD

At least one embodiment of the invention generally relates to a method for setting operating parameters of a data processing system comprising at least one display device and/or to a device suitable for carrying out the method.

### BACKGROUND

WO 02/01321 A2 discloses a method for calibrating the physical pixel size of a monitor. This method operates as an Internet-based solution. To carry out the method the user requires an object of known size, e.g. a 3.5 inch diskette, a CD case or a particular banknote in order to allow a size comparison therewith.

The size in which a graphic element is displayed on a screen is generally dependent on the dimensions and resolution of the screen. As a rule, the number of pixels comprising a particular graphic element such as a control is predefined, so that the higher the screen resolution is set, the smaller the graphic element is reproduced.

When a data processing program is developed, a standard monitor configuration, e.g. a 19 inch monitor with 1280×1024 pixels, is assumed in many cases. Unless this standard monitor configuration is used, all the graphic elements displayed when the data processing program is run will not be displayed in the correct manner as intended when developing the data processing program. Any deviation from the standard monitor configuration generally results in changes in respect of the size and/or positioning of the graphic element on the monitor. Such changes may range from slight impairments of the visibility of the graphic element to loss of information to be displayed on the monitor, e.g. due to unintentional overlapping between different graphic elements.

It is basically possible to design a software product to provide an adjustment to different monitor configurations, whereby each individual monitor configuration can be assigned a configuration file. However, the creation and data management of such configuration files means a considerable additional cost compared to a software product designed for a single monitor configuration. Moreover, the number of monitor configurations to which adjustment is possible is limited in each case.

### SUMMARY

In at least one embodiment of the invention provides a particularly simple, user-friendly method/device of adjusting a data processing system to a visualization system comprising at least one display device.

Embodiments and advantages explained below in connection with the method also apply by analogy to the data processing system and vice versa.

The method, in at least one embodiment, assumes that a data processing system having at least one display device, hereinafter also referred to without limitation of generality as a monitor, is provided. Subsumed under the term “display device” are screens, but not projection devices.

To execute the program, on the one hand a graphic parameter file is accessed which specifies at least one geometric parameter of a graphic element displayable on the display device. On the other hand, a device parameter file is accessed which specifies at least one parameter of the display device. Automatic linking of the graphic parameter file with the device parameter file ensures that, irrespective of the parameters of the display device, the graphic element is always displayed in the desired manner, i.e. with particular geometric properties or parameters, via the display device.

For example, at least one dimension of the graphic element is specified in the graphic parameter file, e.g. the width and/or height measured in cm of the graphic element. In addition, a particular positioning of the graphic element on the display device can be specified in the graphic parameter file. If a graphic element includes characters, separate parameters can be defined for their reproduction.

The device parameter file contains, for example, information about at least one dimension, e.g. the screen diagonal, of the display device. The number of pixels of the display device is preferably specified as further information in the device parameter file. From these two items of information the device-specific relative resolution, which is generally given in dpi (dots per inch), can be calculated automatically. However, the relative resolution of the display device can also be stored in the device parameter file as an explicit value. In this case the method of at least one embodiment can also be carried out in principle without explicitly including the screen dimensions in the calculation.

In an example embodiment, to carry out the method a data processing system is used which comprises a plurality of display devices which differ from one another in respect of their device parameters, in particular the relative resolution. A graphic element can be optionally displayed on different display devices, it being possible to change between the individual display devices, e.g. by switching by way of a keyboard or using a mouse, with which the user moves the graphic element from a first monitor to a second monitor. In each case the method according to at least one embodiment of the invention ensures that a geometric parameter of the graphic element is automatically maintained constant when changing from one display device to another.

In the application described above, it is basically assumed that a particular software package that has been developed on the basis of a standard monitor configuration is used, using different display devices, at least some of which are at variance with the standard monitor configuration. However, cases are also conceivable in which different software modules designed for different monitor configurations, each referred to as a reference system, interact.

Also in such cases, identical or comparable graphic elements used in the different software modules are automatically scaled by the method according to at least one embodiment of the invention to a uniform appearance, in particular a uniform physical size. This applies both when using a uniform monitor configuration within the data processing system and when simultaneously using display devices having different device parameters.

Due to the automatic scaling of the graphic elements, no additions or changes to these modules affecting the parameters of the screen display are required for combining the individual software modules, so that the programming overhead is minimized while providing high flexibility of the software system. The number of different monitor configurations under which the graphic elements are adjusted automatically to a desired appearance that is either permanently preset or freely selectable, is subject to no limitations of any kind.

The particular advantage of at least one embodiment of the invention is that a graphic element, particularly a control, can be moved between different monitors of a data processing system having different resolutions, said graphic element being automatically scaled such that it retains its size.

### BRIEF DESCRIPTION OF THE DRAWINGS

An example embodiment of the method according to the invention and a device suitable for carrying out the method will now be explained in greater detail with reference to the accompanying schematic drawings in which:

FIG. 1 shows a data processing system with a plurality of display devices,

FIG. 2 shows different screen displays that can be generated with the display devices of the data processing system, and

FIG. 3 is a flowchart showing the sequence of a method that can be carried out by the data processing system.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

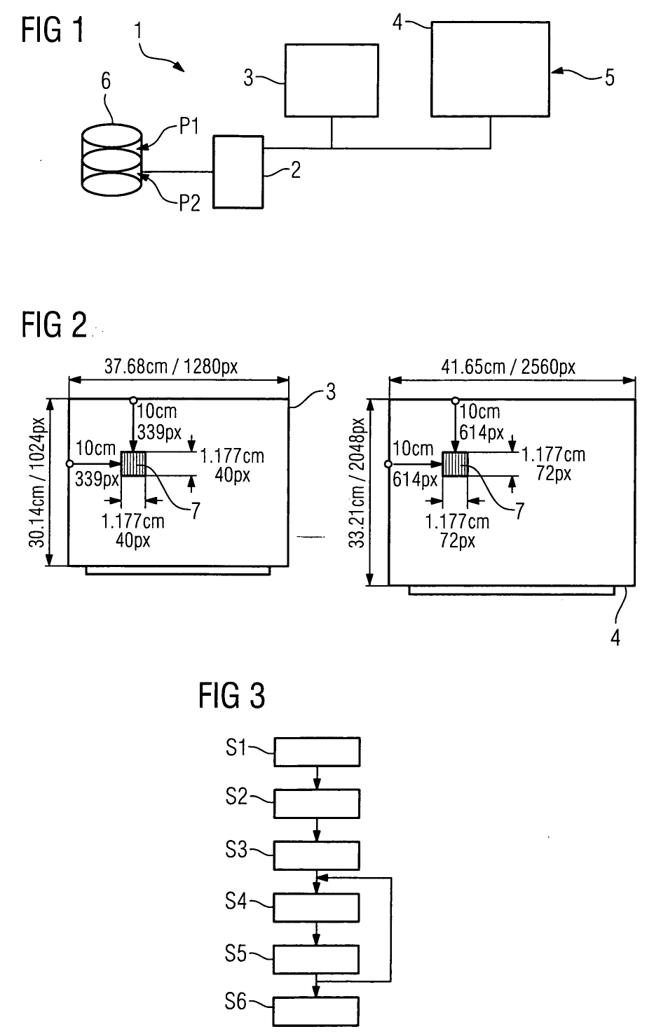

FIG. 1 symbolically illustrates a data processing system 1 comprising a data processing unit 2 and a plurality of display devices 3,4 connected thereto. The totality of the display devices 3,4, the number of which is subject to no limitation, is also termed a visualization system 5. The data processing system 1 is particularly envisioned for use in the medical engineering field, e.g. for processing data acquired using diagnostic imaging devices such as computed tomography or magnetic resonance equipment.

The data processing unit 2 is linked to a data memory 6 which enables a graphic parameter file P1 and a device parameter file P2 to be accessed. While the graphic parameter file P1 contains information relating to geometric parameters of a graphic element that can be displayed on the display device, the device parameter file P2 contains data relating to the display devices 3,4.

The different parameter files P1, P2 are not necessarily held in a single storage medium as is shown for simplicity in FIG. 1. In fact, data storage can be provided anywhere in a data processing network which is identical to the data processing system 1 or connected thereto via a data link. Likewise, the data processing unit 2 can be implemented by any number of interlinked data processing devices.

FIG. 2 shows, side by side, screen views of identical content that can be displayed on the display devices 3, 4. The screen 3, on the left in FIG. 2, is a 19 inch monitor with a resolution of 1280×1024 pixels. The display device 3 is also referred to as the reference screen. At least individual modules of the software running on the data processing system 1 were originally developed for use with such a reference screen. To differentiate it from the screen 3, the display device 4 is referred to as the destination screen. In the exemplary embodiment, this is, say, a 21 inch monitor with a resolution of 2560×2048 pixels. However, a destination screen with any other screen diagonal and resolution can likewise be selected.

On each screen 3,4 a graphic element 7, also termed a control, is visible. The graphic element 7 has a width b and a height h of 1.177 cm in each case. In order to display the graphic element 7 with these dimensions, it must extend over 40 pixels in width and height in the reference system, i.e. for display on the screen 3, each pixel having a width and height of 0.029 mm. The distance of the graphic element 7 from the upper and left-hand edge of the screen is 339 pixels in each case, corresponding to 10 cm.

As may be seen from FIG. 2, on the destination screen 4 both the physical size and the positioning of the graphic element 7 are congruent with the reference system, the orientation relative to the top left-hand corner of the screen governing the disposition of graphic element 7. The orientation of the graphic element 7 in the destination system compared to the reference system could also be determined according to some other rule.

The physical width b and the physical height h of the graphic element 7 is 1.177 cm in the destination system, i.e. for display on the display device 4, the same as in the reference system. In order to achieve this, the following transformations are performed automatically by the data processing unit 2:

ph_{z}=ph_{R}×(B_{R}/B_{Z})×(AH_{Z}/AH_{R})

pv_{z}=pv_{R}×(H_{R}/H_{Z})×(AV_{Z}/AV_{R})

where ph is the horizontal extent, expressed in pixels, of the graphic element 7 and pv the vertical extent, likewise expressed in pixels, of the graphic element 7.

In each case the subscript R stands for the reference system, the subscript Z for the destination system. This also applies to the data of the display devices 3, 4, namely the physical width B and height H as well as the horizontal resolution AH and vertical resolution AV expressed in pixels. If, as in the example embodiment, the screens 3, 4, have coinciding aspect ratios, instead of the width and height in cm or inches of the different display devices 3, 4, the ratio of the screen diagonals, here 19/21, can also be used in a simple manner to convert the pixel counts. Both for the screen 3 of the reference system and for the screen 4 of the destination system it is assumed that all the pixels are square.

If the graphic element 7 is moved from the reference screen 3 to the destination screen 4, scaling takes place which ensures that the appearance of the graphic element 7 does not change, without any user intervention.

The flowchart in FIG. 3 illustrates in simplified form the steps executed during operation of the data processing system 1, step S1 denoting the start of the program. In step S2 the data processing system automatically checks for screens present, the display devices 3, 4 being detected in this case. As run-up continues in step S3, the configuration data of the user interface is read in. In step S4 the user interface elements required during operation of the program, which are to be displayed in the form of graphic elements 7, are created, thereby creating the conditions for visualizing, in step S5, at least one graphic element 7 on a selected screen, e.g. the reference screen 3. The graphic element is visualized with a defined appearance in respect of size, positioning and possibly also character representation, for which purpose appropriate scaling is performed automatically if required.

If the same graphic element 7 and/or another graphic element is also to be displayed subsequently or simultaneously on another screen, namely the destination screen 4, the conditions for this are re-created in step S4. This step is followed again by step S5 in which the element is reproduced on the display device 4 selected. Program termination is denoted by S6. The method is not limited either in respect of the number or in respect of the variety of variants of the display devices 3, 4. Particularly advantageous is the fact that automatic adaptation to any monitor configuration takes place without the need for separately programmed user interfaces for that purpose.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDS; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for setting operating parameters of a data processing system including at least one display device, the method comprising:
providing a graphic parameter file which specifies at least one geometric parameter of a graphic element displayable on the at least one display device;
providing a device parameter file which specifies at least one parameter of the at least one display device;
automatically linking the graphic parameter file with the device parameter file such that the graphic element is displayed with the specified at least one geometric property on the at least one display device, independently of the at least one specified parameter of the display device.

2. The method as claimed in claim 1, wherein the graphic parameter file specifies a dimension of the graphic element as the at least one geometric parameter.

3. The method as claimed in claim 1, wherein the graphic parameter file specifies a positioning of the graphic element on the display device as the at least one geometric parameter.

4. The method as claimed in claim 1, wherein the device parameter file specifies at least one dimension of the display device as the at least one parameter of the at least one display device.

5. The method as claimed in claim 1, wherein the device parameter file specifies the resolution of the display device as the at least one parameter of the at least one display device.

6. The method as claimed in claim 1, wherein the data processing system comprises a plurality of display devices.

7. The method as claimed in claim 6, wherein the display devices include at least one different device parameter.

8. The method as claimed in claim 7, wherein the graphic element is displayed alternately on different display devices.

9. The method as claimed in claim 8, wherein a geometric parameter of the graphic element is retained when switching from a first display device to a second display device.

10. A data processing system, comprising:
at least one display device; and
a data processing unit to interact with the at least one display device and to carry out the method as claimed in claim 1.

11. The method as claimed in claim 2, wherein the graphic parameter file specifies a positioning of the graphic element on the display device as the at least one geometric parameter.

12. The method as claimed in claim 2, wherein the device parameter file specifies at least one dimension of the display device as the at least one parameter of the at least one display device.

13. The method as claimed in claim 2, wherein the device parameter file specifies the resolution of the display device as the at least one parameter of the at least one display device.

14. The method as claimed in claim 2, wherein the data processing system comprises a plurality of display devices.

15. The method as claimed in claim 14, wherein the display devices include at least one different device parameter.

16. The method as claimed in claim 15, wherein the graphic element is displayed alternately on different display devices.

17. The method as claimed in claim 16, wherein a geometric parameter of the graphic element is retained when switching from a first display device to a second display device.

18. A data processing system, comprising:
at least one display device; and
a data processing unit to interact with the at least one display device and to carry out the method as claimed in claim 2.
